(19) United States
(12) Patent Application Publication
(10) Pub. No.: US 2007/0228701 A1
(43) Pub. Date: Oct. 4, 2007

(54) Side airbag apparatus

(75) Inventor: Daisuke Yamamura, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/727,992

(22) Filed: Mar. 29, 2007

(30) Foreign Application Priority Data
Apr. 3, 2006 (JP) 2006-101814

(51) Int. Cl. B60R 21/26; B60R 21/233; B60R 21/207

(52) U.S. Cl. 280/730.2; 280/729; 280/740

(57) ABSTRACT

An airbag includes a seam, which divides the airbag into an upper chamber and a lower chamber. An inner tube is provided inside the airbag such that openings are each located in one of the chambers. An inflator is inserted in the inner tube such that gas blown out from a gas port is oriented toward the lower chamber. A gap formed between an outer circumferential surface of the inflator and an inner circumferential surface of the inner tube during inflation and deployment of the airbag connects the upper chamber to the lower chamber.

### BACKGROUND OF THE INVENTION

The present invention relates to a side airbag apparatus that inflates and deploys an airbag between the side of a vehicle and an occupant.

As an occupant protection device of a vehicle, for example, a side airbag apparatus disclosed in Japanese Laid-Open Patent Publication No. 2005-225351 has been proposed. The side airbag apparatus inflates and deploys an airbag between the side of a vehicle and an occupant seated in a seat when great impact force is applied from the lateral direction of a vehicle, such as in the case of side impact. FIGS. 6 and 7 illustrate the configuration of a conventional side airbag apparatus including that of the above publication.

As shown in FIGS. 6 and 7, the inside of an airbag 102 is divided into an upper chamber 107a and a lower chamber 107b by a tether 106. The chambers 107a, 107b are connected to each other by a communication section 110 (a front communication section 110a and a rear communication section 110b). Among the chambers 107a, 107b, the upper chamber 107a mainly protects the chest of an occupant P seated in a seat 103 when being deployed, and the lower chamber 107b mainly protects the waist of the occupant P when being deployed. Also, an inner tube 108, which connects the chambers 107a, 107b to each other, is provided in the airbag 102, and an inflator 104, which blows out gas from a gas port 104b, is inserted in the inner tube 108. The inner tube 108 has openings 108a and 108b. The opening 108b located in the lower chamber 107b has a greater opening area than the opening 108a located in the upper chamber 107a.

When great impact force is applied to the vehicle from the lateral direction such as in the case of side impact, gas is blown out from the gas port 104b of the inflator 104, and the blown-out gas flows into the chambers 107a, 107b through the inner tube 108. Since the opening 108b of the inner tube 108 located in the lower chamber 107b has a greater opening area than the opening 108a of the inner tube 108 located in the upper chamber 107a, the amount of gas that flows into the lower chamber 107b is greater than the amount of gas that flows into the upper chamber 107a. As a result, the lower chamber 107b is expanded earlier than the upper chamber 107a. Thereafter, when the internal pressure of the lower chamber 107b is increased, some of gas that has flowed into the lower chamber 107b flows into the upper chamber 107a through the communication sections 110a, 110b. Thus, the upper chamber 107a is expanded later than the lower chamber 107b.

In such a side airbag apparatus, in general, the airbag is set to inflate and deploy in a manner such that the airbag does not apply great impact force on the chest of the occupant P while the inflated and deployed airbag reliably receives the waist of the occupant P. Therefore, in the conventional airbag apparatus, by setting the opening 108b of the inner tube 108 located in the lower chamber 107b to have a greater opening area than the opening 108b of the inner tube 108 located in the upper chamber 107a, the lower chamber 107b is expanded earlier than the upper chamber 107a, and the maximum internal pressure of the lower chamber 107b is greater than the maximum internal pressure of the upper chamber 107a when the airbag 102 is inflated and deployed.

However, in such a side airbag apparatus 101, since the areas of gas flow through the communication sections 110a, 110b, which connect the chambers 107a, 107b to each other, irregularly change in accordance with the inflation and deployment condition, the state of gas flow through the communication sections 110a, 110b is unstable. As a result, the change of the internal pressures in the chambers 107a, 107b is also unstable, and there might be no clear difference between the maximum internal pressures of the chambers 107a, 107b.

Depending on the installation condition of the side airbag apparatus or the manner in which a collision occurs, the maximum internal pressure of the upper chamber may be set higher than the maximum internal pressure of the lower chamber. However, in this case also, the above-mentioned disadvantage might occur in the same manner.

### SUMMARY OF THE INVENTION

Accordingly, it is an objective of the present invention to provide a side airbag apparatus having an airbag inside of which is divided into an upper chamber and a lower chamber. The internal pressures of the chambers change stably during inflation and deployment of the airbag and a clear difference is made between the maximum internal pressures.

To achieve the above objective, the present invention provides a side airbag apparatus, which inflates and deploys an airbag between a side of a vehicle and an occupant by gas blown out from a gas port of an inflator. The airbag includes a partition, which divides the inside of the airbag into an upper chamber and a lower chamber. The inside of the airbag is provided with an inner tube arranged such that opening ends of the inner tube are each located in one of the chambers. The inflator is disposed in the inner tube such that gas blown out from the gas port is oriented toward one of the chambers. A gap formed between an outer circumferential surface of the inflator and an inner circumferential surface of the inner tube during inflation and deployment of the airbag connects the upper chamber to the lower chamber.

Therefore, at the initial stage of inflation and deployment of the airbag, most of the gas blown out of the gas port flows into one of the chambers, and the gas that has flowed into the one of the chambers is restricted from flowing into the other chamber by the partition. Thereafter, when the internal pressure of the one of the chambers is increased, the amount of gas that flows from the one of the chambers to the other chamber through the gap between the inflator and the inner tube gradually increases, thus increasing the internal pressure of the upper chamber later. The flow passage area of gas through the gap between the inflator and the inner tube is maintained substantially constant from the initial stage to the completion of inflation and deployment of the airbag. Thus, although the flow rate of gas changes as described above, the state of gas flow through the gap is stable. Since the flow of gas into the chambers is controlled as described above during inflation and deployment of the airbag, the internal pressures of the chambers change in a stable manner. As a result, the maximum internal pressure of the one of the chambers is reliably higher than that of the other chamber. Thus, a clear difference is made between the maximum internal pressures. Moreover, by a simple design modification in which the diameter of the inner tube is changed to adjust, as required, the size of the gap formed between the inner tube and the inflator during inflation and deployment of the airbag, the difference between the maximum internal pressures of the chambers is adjusted with a considerable amount of freedom.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a side view illustrating a side airbag apparatus in a state where an airbag is inflated and deployed in a passenger compartment;

FIG. 2 is a cross-sectional view illustrating the inflated and deployed airbag;

FIG. 3 is a cross-sectional view taken along line 3-3 of FIG. 2;

FIG. 4 is a cross-sectional view taken along line 3-3 of FIG. 2 illustrating the airbag in a folded state;

FIG. 5 is a graph showing changes of the internal pressures of the chambers;

FIG. 6 is a front view illustrating a conventional side airbag apparatus in a state where an airbag is inflated and deployed; and

FIG. 7 is a cross-sectional view illustrating the conventional airbag in an inflated and deployed state.

### DETAILED DESCRIPTION OF PREFERRED EMBODIMENTS

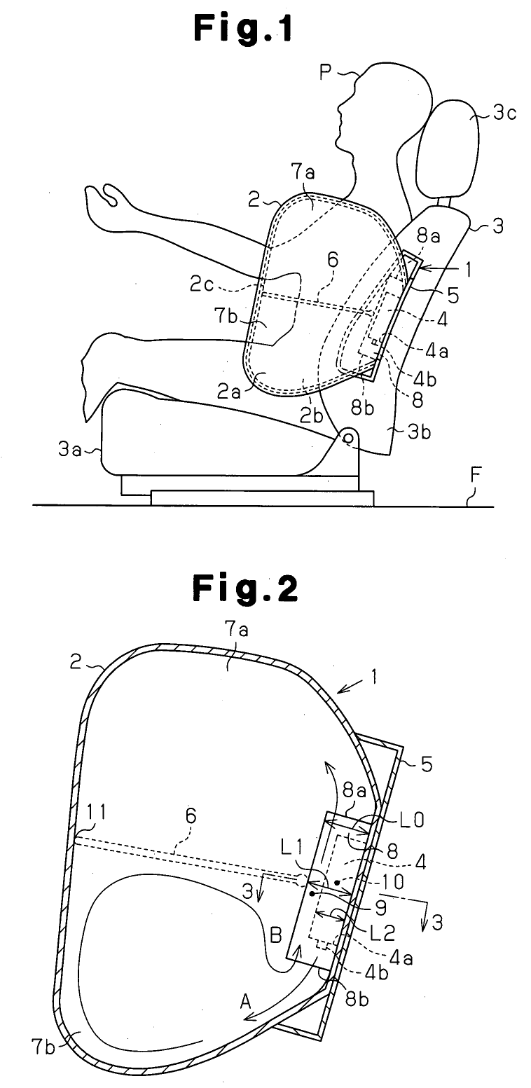

A side airbag apparatus 1 according to one embodiment of the present invention will now be described with reference to FIGS. 1 to 5.

As shown in FIG. 1, a seat 3 is arranged on a floor F of a passenger compartment. The seat 3 is a single front seat located on the left side of the passenger compartment, and includes a seat portion 3a, a backrest 3b, and a headrest 3c.

The vehicle is provided with the side airbag apparatus 1 as one of occupant protection devices. The side airbag apparatus 1 includes a columnar inflator 4, which blows out gas, and an airbag 2, which is inflated and deployed in the passenger compartment by the gas blown out from the inflator 4.

The airbag 2 is accommodated in a case 5 and arranged in the backrest 3b of the seat 3. Although not shown in the drawings, a side airbag apparatus is provided for a seat on the right side of the passenger compartment in the same manner.

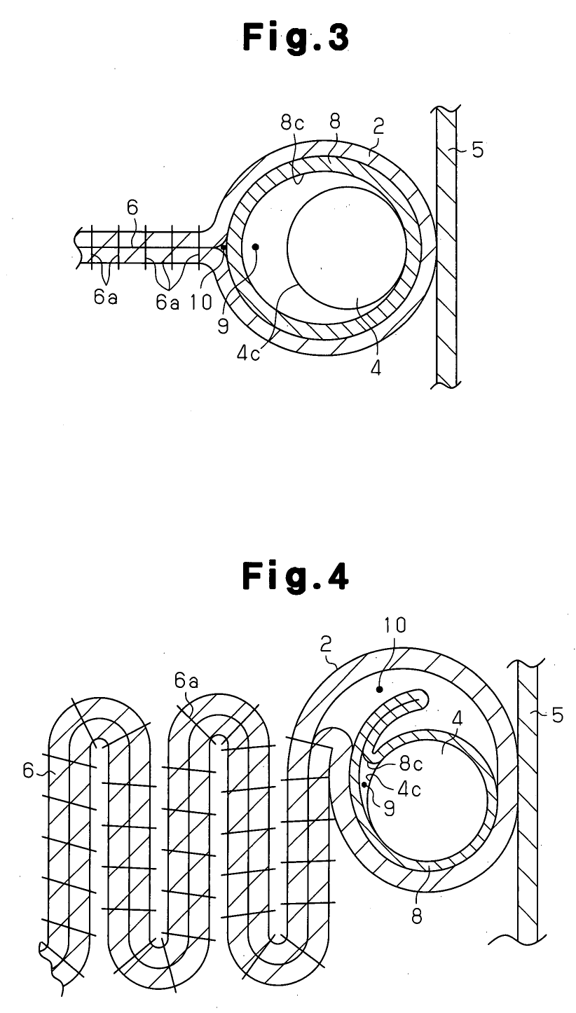

As shown in FIGS. 1 and 2, the airbag 2 is formed into a bag shape by sewing along the periphery of base fabrics 2a, 2b, which are two woven cloths. Also, the airbag 2 has a seam 6 formed by sewing together the base fabrics 2a, 2b with the center portions in contact with each other using a sewing thread 6a (see FIG. 3). The seam 6 functions as a partition for dividing the inside of the airbag 2 into an upper chamber 7a located at the upper section and a lower chamber 7b located at the lower section.

As shown in FIG. 1, when the airbag 2 is inflated and deployed, the seam 6 extends straight in the fore-and-aft direction of the vehicle. The seam 6 permits the upper chamber 7a of the airbag 2 and the lower chamber 7b of the airbag 2 to expand individually. Therefore, part of the airbag 2 corresponding to the upper chamber 7a protects the chest of the occupant P seated in the seat 3, and part of the airbag 2 corresponding to the lower chamber 7b protects the waist of the occupant P.

Also, an inner tube 8 formed by the same woven cloth as the airbag 2 is provided inside and at the rear end of the airbag 2 where the seam 6 is not formed. An upper opening 8a of the inner tube 8 is located in the upper chamber 7a, and a lower opening 8b of the inner tube 8 is located in the lower chamber 7b. Thus, the inner tube 8 connects the upper chamber 7a to the lower chamber 7b from the middle to the end of inflation and deployment of the airbag 2.

The columnar inflator 4 is inserted in the inner tube 8. A lower end 4a of the inflator 4 is located at the lower part of the inner tube 8, and a gas port 4b for blowing out gas to inflate and deploy the airbag 2 is formed at the lower end 4a of the inflator 4. Furthermore, since the inflator 4 is secured to a seat frame (not shown) housed in the backrest 3b via the case 5 with a bolt (not shown), the airbag 2 and the inner tube 8 are also secured to the seat frame of the backrest 3b via the case 5. In this state, the gas port 4b of the inflator 4 is located in the lower chamber 7b offset from the seam 6.

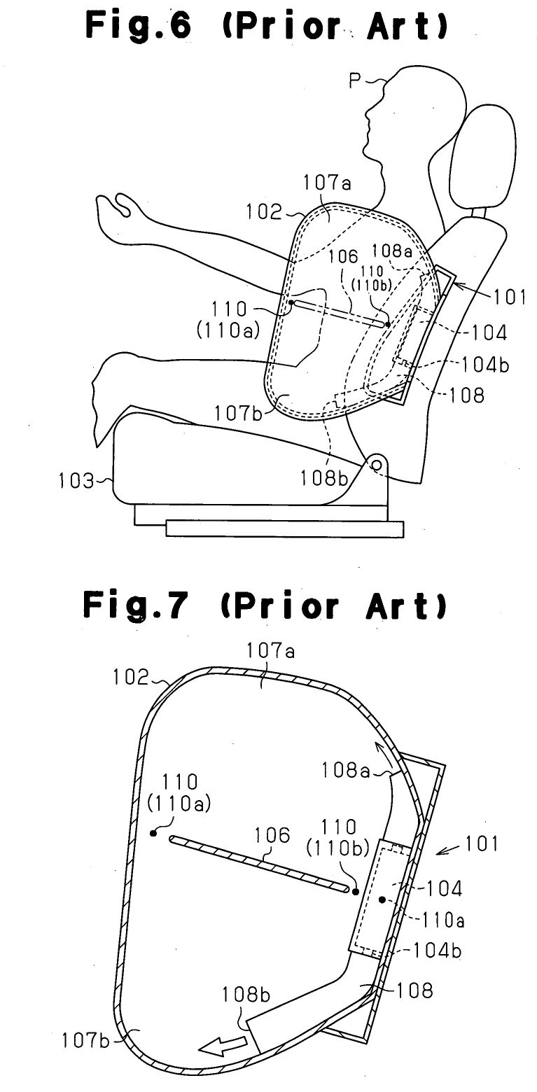

As shown in FIG. 3, the inner diameter of the inner tube 8 is set greater than the outer diameter of the inflator 4. When the airbag 2 is inflated and deployed, a gap 9 is formed between an outer circumferential surface 4c of the inflator 4 and an inner circumferential surface 8c of the inner tube 8. More specifically, as shown in FIG. 2, in a state where the airbag 2 is not expanded and placed flat, the length L0 of the inner tube 8 is set to 70 mm, and the length L1 from the rear end of the airbag 2 to the rear end of the seam 6 is set to 65 mm. Furthermore, the outer diameter of the inflator 4 is set to 36 mm. The inner tube 8 is made of woven cloth, and is flexible. Therefore, even if the length L0 of the inner tube 8 is longer than the length L1 from the rear end of the airbag 2 to the rear end of the seam 6, the inner tube 8 is easily inserted between the rear end of the airbag 2 and the rear end of the seam 6. Even if the amount of gas blown out from the inflator 4 is small, the diameter of the inner tube 8 is quickly increased by the internal pressure. Therefore, the area through which gas flows in the gap 9 is maintained substantially constant from the very initial stage to the completion of inflation and deployment of the airbag 2. Also, in this region, a space 10 (see FIGS. 3 and 4) formed between the inner tube 8 and the airbag 2 is substantially closed. Thus, the upper chamber 7a is connected to the lower chamber 7b only by the inner tube 8. The space 10 corresponds to the rear communication section 10b of the conventional airbag 102 (see FIG. 6). In the example of this application, the region corresponding to the front communication section 110a of the conventional airbag 102 is, as shown in FIG. 2, a portion 11 where a sewn section 2c (see FIG. 1) of the front outer circumferential portion of the airbag 2 and the front end of the seam 6 contacts. However, the upper chamber 7a is not connected to the lower chamber 7b in this region.

Also, the airbag 2 is accommodated in the case 5 in a state where the airbag 2 is folded from the front end toward the rear end. When the airbag 2 is folded in such a manner, the inner tube 8 is crushed with its diameter reduced. Thus, as shown in FIG. 4, the gap 9 between the outer circumferential surface 4c of the inflator 4 and the inner circumferential surface 8c of the inner tube 8 is narrowed. The inner tube 8 is preferably accommodated in a state where the gap 9 is substantially closed.

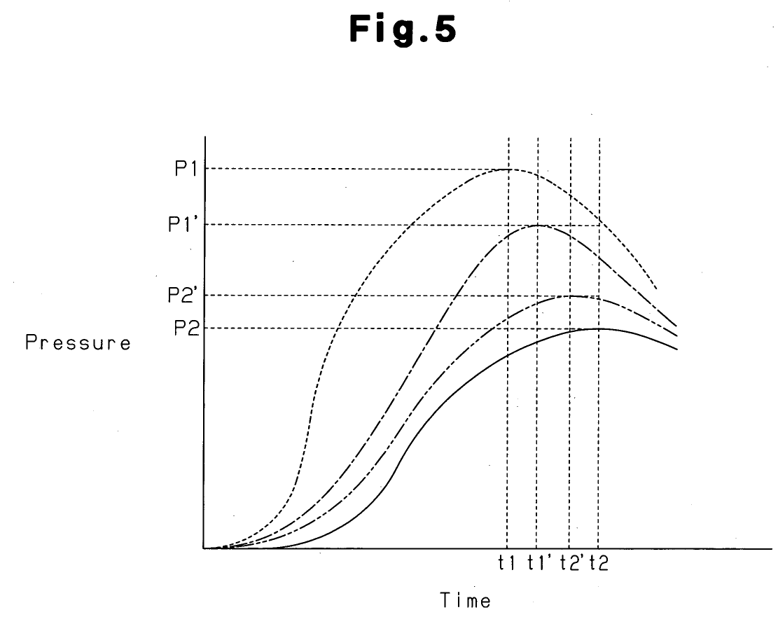

The operation of the side airbag apparatus 1 will now be described. FIG. 5 schematically shows changes of the internal pressures in the chambers 7a, 7b from the start of inflation and deployment of the airbag 2. The changes of the internal pressure of the upper chamber 7a are shown by a solid line, and the changes of the internal pressure of the lower chamber 7b are shown by a broken line. As a comparison data, changes of the internal pressure of a lower chamber of the conventional airbag apparatus are shown by a dashed line, and the changes of the internal pressure of an upper chamber of the conventional airbag apparatus are shown by a chain double-dashed line. The vertical axis represents the internal pressure, and the horizontal axis represents the time.

When impact force greater than or equal to a predetermined value is applied from the side of the vehicle such as when another vehicle collides against the side of the vehicle, the collision is detected by a collision sensor of the vehicle. A drive current is then sent to the inflator 4 from a control circuit of the vehicle, which causes an igniter (not shown) to ignite the inflator 4. As a result, as shown in FIG. 2, gas is generated from a gas generating agent of the inflator 4, and the gas is blown out from the gas port 4b.

As described above, the gas port 4b is inserted in the inner tube 8 such that the gas port 4b is located at the bottom, and offset toward an inner part of the lower chamber 7b. The inner tube 8 is collapsed in the space 10 formed between the rear end of the airbag 2 and the seam 6 so that the diameter of the inner tube 8 is reduced. Therefore, at the initial stage of the inflation and deployment, most of the gas flows into the lower chamber 7b through the lower opening 8b. Also, since the gas port 4b is located at the lower section of the lower chamber 7b, the gas flows in along the lower section of the lower chamber 7b as shown by arrow A in FIG. 2. Some of the gas also attempts to flow into the gap 9 in addition to the direction of arrow A. However, since the gap 9 is closed or extremely small at the initial stage of the expansion, the gas can hardly pass through the gap 9. Thus, most of the blown-out gas flows into the lower chamber 7b.

Furthermore, as the gas blown out from the inflator 4 fills the inner tube 8, the inner tube 8 is expanded so that the diameter of the inner tube 8 is increased. This causes the rear end of the seam 6 to closely contact the inner tube 8 to close the space 10 in the airbag 2. Thus, the chambers 7a, 7b are substantially isolated from each other during inflation and deployment of the airbag 2. Therefore, the gas that has flowed into the lower chamber 7b through the gap 9 hardly flows into the upper chamber 7a, and substantially only some of gas that is directly supplied to the inner tube 8 from the inflator 4 directly flows into the upper chamber 7a. Thus, as shown in FIG. 5, although the internal pressure of the lower chamber 7b starts increasing at the initial stage of inflation and deployment, the internal pressure of the upper chamber 7a hardly increases.

When the inflation and deployment of the airbag 2 further proceeds and the total amount of blown-out gas is increased, the lower chamber 7b is filled with gas so that the airbag 2 and the inner tube 8 are unfolded. When the lower chamber 7b is sufficiently expanded by the gas that fills the lower chamber 7b, excessive gas starts flowing into the upper chamber 7a through the gap 9 between the inner tube 8 and the inflator 4 as shown by arrow B in FIG. 2. Thus, expansion of the upper chamber 7a takes place.

As described above, unless the lower chamber 7b is filled with gas, sufficient amount of gas will not flow into the upper chamber 7a and expansion of the upper chamber 7a will not start. Therefore, as shown in FIG. 5, the upper chamber 7a expands later than the lower chamber 7b, and time t2 at which the internal pressure of the upper chamber 7a reaches a maximum internal pressure P2 is later than time t1 at which the internal pressure of the lower chamber 7b reaches a maximum internal pressure P1.

Also, the maximum internal pressure P1 of the lower chamber 7b is higher than a maximum internal pressure P1′ of the conventional lower chamber. Time t1 at which the internal pressure of the lower chamber 7b reaches the maximum internal pressure P1 is also earlier than time t1′ at which the internal pressure of the conventional lower chamber reaches the maximum internal pressure P1′.

The maximum internal pressure P2 of the upper chamber 7a is lower than a maximum internal pressure P2′ of the conventional upper chamber, and time t2 at which the internal pressure of the upper chamber 7a reaches the maximum internal pressure P2 is later than time t2′ at which the internal pressure of the conventional upper chamber reaches the maximum internal pressure P2′. The size of the chambers 7a, 7b during expansion is set such that parts of the airbag 2 corresponding to the chambers 7a, 7b contact the occupant P earlier than time t2 at which the internal pressure of the upper chamber 7a reaches the maximum internal pressure P2 and time t1 at which the internal pressure of the lower chamber 7b reaches the maximum internal pressure P1.

Most of the gas that fills the upper chamber 7a is some of the gas that has once filled the lower chamber 7b and flowed through the gap 9 after convection in the lower chamber 7b. Therefore, the amount of gas that flows into the upper chamber 7a is inevitably smaller than the amount of gas that flows into the lower chamber 7b. Also, since the flow passage area of gas through the gap 9 is maintained substantially constant by the pressure of the gas blown out from the inflator 4 after the airbag 2 is unfolded, the flow passage area of gas through the gap 9 does not change irregularly by time, and the state of gas flow through the gap 9 is relatively stable. That is, as shown in FIG. 5, the maximum internal pressure of the lower chamber 7b is reliably higher than that of the upper chamber 7a, and a clear difference is made between the maximum internal pressures P1, P2. Therefore, when the airbag 2 is inflated and deployed, expansion of the lower chamber 7b receives the waist of the occupant P at the initial stage, and pushes the occupant P toward the center of the vehicle. Thus, the contact force is prevented from being excessive when the upper chamber 7a of the airbag 2 is expanded and contacts the chest of the occupant P.

The side airbag apparatus 1 according to the preferred embodiment has the following advantages.

(1) At the initial stage of inflation and deployment of the airbag 2, most of the gas blown out of the gas port 4b flows into the lower chamber 7b, and the gas that has flowed into the lower chamber 7b is restricted from flowing into the upper chamber 7a by the seam 6, the airbag 2, and the inner tube 8. Thereafter, when the internal pressure of the lower chamber 7b is increased, the amount of gas that flows from the lower chamber 7b to the upper chamber 7a through the gap 9 between the inflator 4 and the inner tube 8 gradually increases, thus increasing the internal pressure of the upper chamber 7a. The flow passage area of gas through the gap 9 between the inflator 4 and the inner tube 8 is maintained substantially constant from the initial stage to the completion of inflation and deployment of the airbag 2. Thus, although the flow rate of gas changes as described above, the state of gas flow through the gap 9 is stable. Since the flow of gas into the upper chamber 7a is controlled as described above during inflation and deployment of the airbag 2, the internal pressures of the chambers 7a, 7b change in a stable manner. As a result, the maximum internal pressure of the lower chamber 7b is reliably higher than that of the upper chamber 7a. Thus, unlike the conventional airbag apparatus, a clear difference is made between the maximum internal pressures.

Furthermore, since the internal pressure of the upper chamber 7a starts increasing later than the lower chamber 7b, a clear difference is made between the internal pressures of the chambers 7a, 7b even at the initial stage of inflation and deployment. As a result, the difference between the internal pressures of the chambers 7a, 7b when the lower chamber 7b receives the waist of the occupant P is increased. Thus, the part corresponding to the lower chamber 7b reliably receives the waist of the occupant P, and the contact force of the part corresponding to the upper chamber 7a against the chest of the occupant P is reduced.

Moreover, by a simple design modification in which the diameter of the inner tube 8 is changed to adjust, as required, the size of the gap 9 formed between the inner tube 8 and the inflator 4 during inflation and deployment of the airbag 2, the difference between the maximum internal pressures of the chambers 7a, 7b and the times at which the internal pressures are increased are adjusted with a considerable amount of freedom.

(2) The lower end 4a of the inflator 4 at which the gas port 4b is formed is offset toward an inner part of the lower chamber 7b in the inner tube 8. Therefore, at the initial stage of inflation and deployment of the airbag 2, more gas flows into the lower chamber 7b, which further increases the difference between the internal pressures of the chambers 7a, 7b at the initial stage of inflation and deployment and the difference between the maximum internal pressures of the chambers 7a, 7b.

(3) The airbag 2 is accommodated in a folded state to close the gap 9 between the outer circumferential surface 4c of the inflator 4 and the inner circumferential surface 8c of the inner tube 8. Therefore, the gap 9 between the outer circumferential surface 4c of the inflator 4 and the inner circumferential surface 8c of the inner tube 8 is closed by the airbag 2 immediately after gas is blown out from the gas port 4b at the initial stage of inflation and deployment of the airbag 2. Thus, the gas hardly passes through the gap 9, and most of the blown-out gas flows into the lower chamber 7b. Therefore, at the initial stage of inflation and deployment, the difference between the internal pressures of the chambers 7a, 7b and the difference between the maximum internal pressures of the chambers 7a, 7b are further increased.

The preferred embodiment may be modified as follows.

The airbag 2 is divided into the upper chamber 7a and the lower chamber 7b by the seam 6. However, the airbag 2 may be divided by employing other configurations such as a joint using a tether or an adhesive.

When the airbag 2 is accommodated in a folded state, the inner tube 8 is also folded to close the gap 9 between the inner tube 8 and the inflator 4. However, the airbag 2 may be accommodated in a state where the inner tube 8 is not folded and the gap 9 exists. In this case also, the advantages equivalent to the advantages (1) and (2) are obtained.

In a case where a configuration is employed in which the lower end 4a of the inflator 4 is offset toward an inner part of the upper chamber 7a in the inner tube 8, if the gas blown out of the gas port 4b is oriented toward the lower chamber 7b, the advantage equivalent to the advantage (1) is obtained.

In an airbag in which the upper chamber needs to have a greater maximum internal pressure than the lower chamber, the advantages equivalent to the advantages (1) to (3) are obtained by applying the configuration of the airbag according to the preferred embodiment. In this case, the inflator 4 is inserted in the inner tube 8 such that the gas blown out from the gas port 4b is oriented toward the upper chamber 7a. Also, the gas port 4b is formed at the upper end of the inflator 4, and the upper end is offset toward an inner part of the upper chamber 7a in the inner tube 8.

1. A side airbag apparatus, which inflates and deploys an airbag between a side of a vehicle and an occupant by gas blown out from a gas port of an inflator, the apparatus comprising:
a partition, which divides the inside of the airbag into an upper chamber and a lower chamber; and
an inner tube located inside the airbag such that opening ends of the inner tube are each located in one of the chambers,
wherein the inflator is disposed in the inner tube such that gas blown out from the gas port is oriented toward one of the chambers, a gap formed between an outer circumferential surface of the inflator and an inner circumferential surface of the inner tube during inflation and deployment of the airbag connects the upper chamber to the lower chamber.

2. The side airbag apparatus according to claim 1,
wherein the gas port is formed at an end of the inflator, and the inflator is disposed in the inner tube such that the end is located in one of the chambers.

3. The side airbag apparatus according to claim 2,
wherein the end of the inflator at which the gas port is formed is offset toward an inner part of one of the chambers in the inner tube.

4. The side airbag apparatus according to claim 2,
wherein the airbag is accommodated in a folded state to close the gap between the outer circumferential surface of the inflator and the inner circumferential surface of the inner tube.

5. The side airbag apparatus according to claim 1,
wherein the inflator is disposed in the inner tube such that gas blown out from the gas port is oriented toward the lower chamber.
